(19) United States
(12) Patent Application Publication
(10) Pub. No.: US 2006/0183500 A1
(43) Pub. Date: Aug. 17, 2006

(54) Activating an identity module for a communication system

(75) Inventor: Simon Choi, Singapore (SG)

Correspondence Address: OSHA LIANG L.L.P., 1221 MCKINNEY STREET, SUITE 2800, HOUSTON, TX, 77010, US

(73) Assignee: Schlumberger Systemes, Montrouge (FR)

(21) Appl. No.: 10/507,568

(22) PCT Filed: Mar. 12, 2003
(86) PCT No.: PCT/IB03/01077

§ 371 Date: Apr. 12, 2005

(30) Foreign Application Priority Data
Mar. 12, 2002 (CN) 02104156.3

(51) Int. Cl. H04B 1/38

(52) U.S. Cl. 455/558; 713/168; 455/411

(57) ABSTRACT

An identity module is activated in the following manner. A customization center stores an initial identity code in the identity module and communicates the initial identity code to a network management system. A distributor assigns a communication address to the identity module and communicates the communication address together with the initial identity code to the network management system. The identity module contacts the network management system via a communication device, whereby the network management system receives the initial identity code together with the communication address. The network management system recognizes the initial identity code together with the communication address and, in response, assigns an effective identity code to the identity module. Subsequently, the network management system sends a message to the communication device. This message comprises the effective identity code. The identity module receives the message via the communication device, extracts the effective identity code form the message and stores the effective identity code for future use.

### FIELD OF THE INVENTION

The invention relates, inter alia, to a method of activating an identity module for a communication system. The identity module may be, for example, a subscriber identity module (SIM) card for a mobile communication network, such as, for example, a GSM network.

### BACKGROUND OF THE INVENTION

In existing SIM card allocation mechanisms, a telephone number (e.g. a Mobile Station ISDN (MSISDN) number, 1390XXXXXXX) is associated with an international mobile station subscriber identifier (IMSI). The telephone number and the IMSI code are stored in a SIM card, before the SIM card is delivered together with a mobile phone to a subscriber. The IMSI code may be correlated to a certain geographical zone and a home location register (HLR) belonging to a commercial agent in that zone. This correlation can cause certain inconveniences. For example, it may happen that SIM cards for a certain zone run out of stock, whereas there may still be sufficient SIM cards available for another zone. However, the latter SIM cards cannot be used in the zone where SIM cards have run out of stock because of the IMSI code, which is not correct. The commercial agent for the zone where SIM cards have run out of stock has therefore no option other than order new SIM cards SIM cards for his zone and waiting for the delivery thereof. Meanwhile, he is out of stock. Typically, a commercial agent will try to avoid this. It forces the commercial agent to have a stock of relatively appreciable size, which requires a fairly large amount of capital. Large inventories and non-smooth capital velocity are the negative consequences. Moreover, there is, in effect, a waste of IMSI code resources due to under-utilized SIM card in other regions.

### SUMMARY OF THE INVENTION

It is an object of the invention to activate identity modules in a manner that allows better economy.

To that end, the invention provides an identity module, a method of activating an identity module, a network management system, and a computer program product as defined in the appended claims.

For example, in GSM network systems, the invention allows over-the-air and SIM card activation. When a subscriber buys a new SIM card, he or she can download the IMSI code over-the-air by using the method in accordance of the invention where after the subscriber can use the SIM card smoothly. Such an over-the-air SIM card activation in accordance with the invention removes restrictions on HLR zone distribution on available SIM card IMSI codes, which restrictions are inherent to the existing technology. Consequently, the invention allows commercial agents or resellers to reduce their inventory, to increase their capital velocity, and to improve the utilization of IMSI code. It also allows subscribers to purchase SIM cards in a more conveniently and easy fashion.

These and other aspects of the invention will be described in greater detail hereinafter with reference to drawings.

### BRIEF DESCRIPTION OF THE DRAWINGS

FIG. 1 illustrates the wireless network system to enable over-the-air SIM card;

FIG. 2 illustrates the structure blocks of SIM card;

FIG. 3 illustrates the further composition of OTA server to enable over-the-air SIM card activation;

FIG. 4 illustrates the method to enable over-the-air SIM card activation by calling on the perspective of commercial agent;

FIG. 5 illustrates the method to enable over-the-air SIM card activation by sending short message on the perspective of commercial agent;

FIG. 6 illustrates the method to enable over-the-air SIM card activation by calling in case of reseller participation;

FIG. 7 illustrates the method to enable over-the-air SIM card activation by sending short message in case of reseller participation;

### DETAILED DESCRIPTION

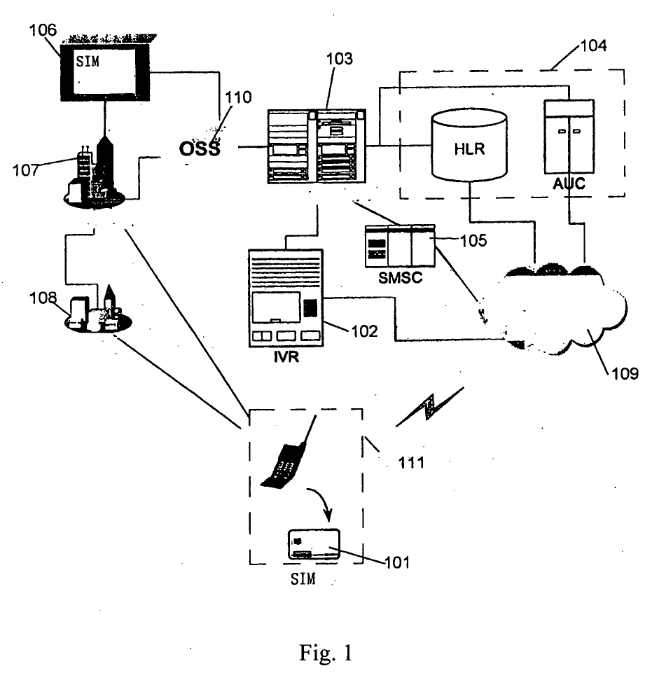

FIG. 1 illustrates a wireless network system 100 in accordance with the invention, which allows over-the-air SIM card activation. The wireless network system 100 comprises: a SIM card 101, an Interactive Voice Response (IVR) sub-system 102, an Over-The-Air-announcement(OTA) server 103, a Home Location Register/Authentication Center (HLR/AUC) database 104, an Short Message Service Center (SMSC) element 105, a SIM card customization center 106, a commercial agent 107, a retailer 108, a wireless network 109, an Operation Support System (OSS) network 110, and a subscriber 111.

The SIM card 101 according to the invention complies the standards issued by the European Telecommunications Standards Institute (ETSI) relating to the Global System for Mobile communications (GSM), which standards are incorporated by reference herein. In particular, the SIM card complies with the over-the-air download specifications known as SMS-PP in the GSM standards.

In a SIM card factory, an initial IMSI code and an initial key are assigned to the SIM card. When the subscriber 111 is registered, the initial IMSI code is replaced by an effective IMSI code with a special short message received from SMSC element 105. Likewise, the initial key can be replaced by an effective key.

The IVR sub-system 102 operates like a call center and can automatically respond to a call from the subscriber 111 holding the SIM card 101. The MSISDN number is extracted from the call, and sent to the OTA server 103 to inform that the subscriber 111 is requesting activation of his SIM card 101.

The OTA server 103 may provide various functions: subscriber management, group management, SIM card data file updating, SIM card profiling management, multi-SIM card vendor support, message tracking, usage report generation, send/receive short message (SMS) and HLR/AUC subscriber data updating. These functions can be accessed through one or more interfaces, such as, for example, a graphic user interface (GUI) and an application program interface (API). The OTA server 103 receives the customized SIM card information to provide interactive wireless communication service to the subscriber 111 and assigns the effective IMSI code to the SIM card 101. The specific components and functions are described in greater detail hereinafter.

The OTA server 103 is responsible for all the requests from the commercial agent 107, the IVR sub-system 102 and the SMSC element 105, and for updating the, appropriate subscriber record in the HLR/AUC database 104.

The HLR/AUC database 104 can be part of an ordinary HLR or AUC known in GSM to store subscriber data and perform data security authentication. The HLR/AUC database 104 uses a user name and a password to authenticate the subscribers with different rights, and records all the attempts to connect the wireless network 109 via a platform. All the passwords are stored in encrypted format. The security protocol in the invention is compliant with GSM 3.48 standard with L3 security support.

The interface between the OTA server 103 and the HLR/AUC database 104 is a TCP/IP connection. The TCP/IP connection may be, for example, in the form of a X.25 line, or a serial communication port or a direct LAN connection. The connection between the OTA server 103 and the IVR sub-system 102 is a TCP/IP connection defined by the OTA server 103. The interface between the IVR sub-system 104 and the wireless network 109 is used for voice, and supports dial-up transmission.

The OTA server 103 manages the interface between the SIM card 101 and the wireless network 109. This management allows a profiling of the SIM card 101 based on, for example, the following features:

| Wireless Features | Description | SIM File |
|---|---|---|
| ADN-FDN transfer | Capability to transfer the subscriber from | EF_AFSWIT |
| | automatic directory number (AND) to a fixed | CH |
| | directory number (FDN), or vice versa. When the | |
| | subscriber is transferred to an FDN directory, only | |
| | the telephone number on the FDN directory is | |
| | allowed to dial. | |
| Send message | Capability to deliver a short text message to the | EF_SMS |
| | subscriber over-the-air. Basically, it functions as | |
| | a “pager”. | |
| MSISDN | Capability to add, modify and delete telephone | EF_MSISDN |
| management | numbers in subscriber's personal telephone | |
| | number file (typically voice telephone number, fax | |
| | number, data phone number) | |
| Language | Capability to add, modify, delete and store a | EF_LP |
| selection | preferred language in a SIM card language list. | |
| IMSI code | Capability to modify or delete and store the IMSI | EF_IMSI |
| | code on a SIM card. | |
| SMS parameters | Capability to modify, delete or store the SMSC | EF_SMSP |
| | address on a SIM card. | |
| Lock PIN1 | Capability to lock PIN1 (=CHV1) | 0000 |
| Lock/unlock PIN2 | Capability to lock or unlock PIN 2 (=CHV2) | 0100 |
| SPN | Capability to update the file that contains a service | EF_SPN |
| | provider name (SPN) over-the-air. | |

The OTA server 103 is interfaced with the commercial agent 107 through a TCP/IP connection over the OSS network 110. The interface between the OTA server 103 and the SMSC element 105 is an ordinary TCP/IP interface in a short message center based on, for example, a protocol known as SMPP or CMID.

In addition, the wireless network system 100 also provides the following features: the HLR/AUC database 104 can be updated through the OTA server 103; a hotline belonging to the IVR sub-system can be activated; the commercial agent 107 can access the OTA server 103 through the OSS network 110; and applications on the SIM card 101 support over-the-air service.

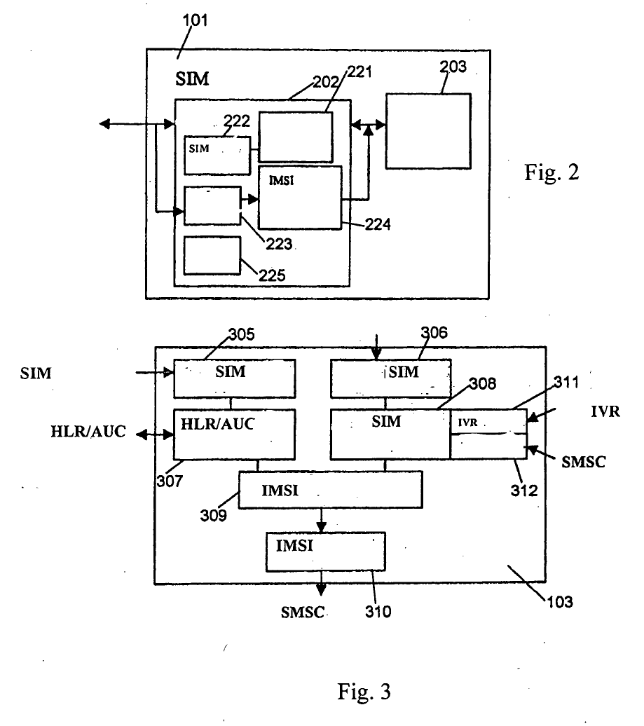

FIG. 2 illustrates the SIM card 101. The SIM card 101 comprises a processor 202 and a storage medium 203 in which pre-sales initial information can be stored such as, for example, an initial IMSI code. The processor 202 includes a boot element 221 used to start a SIM card program when the SIM card 101 is initially installed to a mobile terminal and receives a power supply voltage. The boot element 221 causes the processor 202 to receive the MSISDN assigned by the commercial agent 107. A SIM-card messaging element 222 sends the initial IMSI code and the MSISDN number of the SIM card to the OTA server 103 via the mobile terminal. A short message interpretation element 223 processes a special short message from the OTA server 103. The special short message contains the effective IMSI code that the OTA server 103 has assigned to the SIM card. The short message interpretation element 223 extracts the effective IMSI code from the special short message. An IMSI code update element 224 replaces the initial IMSI code stored in the storage medium 203 by the effective IMSI code.

The processor 202 of the SIM card 101 also includes a reboot element 225. The reboot element 225 reboots the mobile terminal after the IMSI code in the SIM card 101 has been updated as described hereinbefore. To that end, the mobile terminal is shut down and, subsequently, restarted to configure mobile terminal with the SIM card 101 contained therein for normal operation. The messaging element 222 of the SIM card 101 includes a fixed directory number (FDN)element (not shown) used to call IVR sub-system 102 via the mobile terminal. The IVR sub-system 102 automatically responds to the call and extracts the MSISDN number of the SIM card 101 and sends the MSISDN number to the OTA server 103.

The messaging element 222 of SIM card 101 includes a short message delivery element (not shown) that sends a short message to the SMSC element 105 via the mobile terminal. The short message contains the initial IMSI code and MSISDN number. The SMSC element 105 delivers the short message to the OTA server 103.

The SIM card 101 may comprise further elements, such as, for example, application programs or other programming code. The SIM card 101 processes the reception and the sending of short message. Furthermore, the SIM card 101 can update one or more profiles contained in the SIM card 101 and handle the interchange of automatic directory numbers (ADN) and fixed directory numbers (FDN).

FIG. 3 illustrates the OTA server 103. The OTA server 103 comprises a customized SIM card information receiving part 305, which receives initial information of the SIM card 101 from the SIM card customization center 106. The initial information includes the initial IMSI code of the SIM card 101. The OTA server 103 further comprises a commercial agent SIM card information receiving part 306, which receives sold SIM card information from the commercial agent 10. The sold SIM card information comprises the MSISDN number and the initial IMSI code. The OTA server further comprises a HLR/AUC database management part 307, which stores effective SIM card information in the HLR/AUC database 104 and which activates subscriber 111 in the HLR/AUC database 104. The OTA server 103 further comprises a subscriber SIM card information receiving part 308, which receives the SIM card information containing the MSISDN number and initial the IMSI code from the mobile terminal with the sold SIM card 101 inserted therein. The OTA server 103 further comprises an IMSI code allocation part 309, which allocates an effective IMSI code appropriate for the region concerned and which allocates the HLR where the subscriber is located to the subscriber MSISDN number. The effective IMSI code replaces the initial IMSI code initially contained in the SIM card 101. The OTA server 103 further comprises a short message delivery part 310, which sends a special short message containing the effective IMSI code to the subscriber's mobile terminal through the SMSC element 105.

The subscriber SIM card information receiving part 308 of OTA server 103 also includes a short message processing part 312 and an IVR processing part 311. The short message processing part 312 receives short messages containing the SIM card information from SMSC element 105, and extract the MSISDN number. The IVR processing part 311 receives MSISDN number of the subscriber from IVR sub-system 102.

The OTA server 103 further comprises a module for remote SIM card management (not shown), hereinafter referred to as GSM file manager (GFM). The GFM can manage the following information: directory data (ADN, FDN, service directory numbers (SDN), language selection, SMSC (short message service center) related information, subscriber numbers MSISDN number and IMSI code) and personal identification numbers (PIN). The OTA server 103 implements the following features:
Initialization of the SIM card 101 through a GUI:
SIM program management for example in the form of a private-announcement agreement among several SIM card manufacturers and compatible with the standard GSM 03.48v8 for SIM card management;
Interfaces to different SIM card resellers;
GSM 03.48v8 compliant transmission layer security;
Capability to track the state of a request state with GUI monitoring;
Short message error management;
System management and system monitoring capability;
High availability manager;
Resilience.

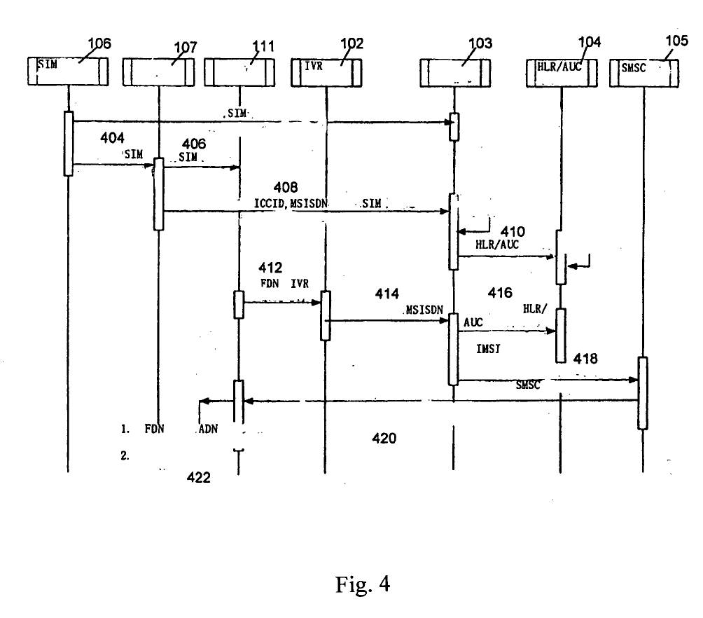

FIG. 4 illustrates a method of over-the-air SIM card activation in accordance with the invention. In step 404, the SIM card customization center 106 customizes SIM card 101 and allocates the customized SIM card 101 to the commercial agent 107. Furthermore, the SIM card customization center 106 delivers the initial information of the SIM card 101 to the OTA server 103. The initial information comprises the initial IMSI code temporarily assigned to the SIM card 101 and the integrated circuit card identifier (ICCID) code. In step 406, the commercial agent 107 sells the SIM card 101 to the subscriber 111 and assigns a MSISDN number to the SIM card 101. In step 408, the commercial agent 107 delivers SIM card information to the OTA server 103. This SIM card information comprises the initial IMSI code, the ICCID code and the MSISDN number. The OTA server 103 stores this information in its database.

Next, in step 410, the OTA server 103 is synchronized with the HLR/AUC database 104. That is, the SIM card information contained in the database of the OTA server 103 is copied into the HLR/AUC database 104. In this manner, the OTA server 103 activates the subscriber 111 in the HLR/AUC database 104. In step 412, the subscriber 111 calls the IVR sub-system 102 whose number is contained in the FDN. In step 414, the IVR sub-system 102 automatically responds to this call and, in addition, extracts and delivers the MSISDN number from the call to the OTA server 103. In step 416, the OTA server 103 assigns the effective IMSI code to the subscriber 111, and updates the record of subscriber 111 in HLR/AUC database 104 accordingly. In addition, in step 418, the OTA server 103 sends a special short message to SMSC element 105 in an appropriate defined format. The special short message contains the effective IMSI code of subscriber 111.

Next, in step 420, the SMSC element 105 sends the special short message with the effective IMSI code contained therein to the subscriber 111. In step 422, the subscriber 111 successfully receives the special short message. The IMSI update element 224 contained in the SIM card 101 replaces the initial IMSI code with the effective IMSI code and changes the fixed number directory (FDN) into an automatic number directory (AND). Furthermore, the IMSI update element 114 assigns an effective key Ki to the SIM card 101 and then shuts down the terminal. The system setting is completed when the terminal is switched on again.

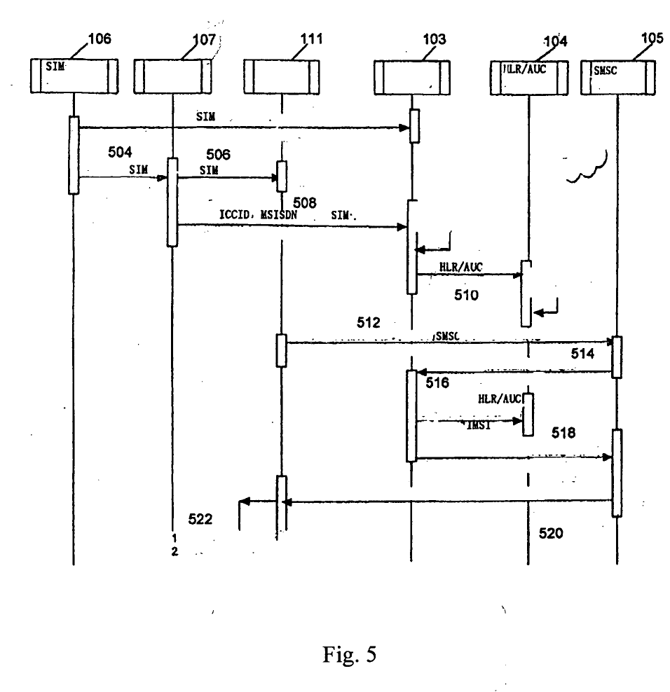

FIG. 5 illustrates another method of over-the-air SIM card activation. This method uses short message services. In step 504, the SIM card customization center 106 customizes the SIM card 101, allocates the customized SIM card 101 to the commercial agent 107, and delivers initial information of the SIM card 101 to the OTA server 103. The initial information comprises the initial IMSI code and the ICCID code temporarily assigned to the SIM card 101. In step 506, the commercial agent 107 sells the SIM card 101 to the subscriber 111 and allocates an MSISDN number to the SIM card 101. In step 508, the commercial agent 107 delivers SIM card information comprising the initial IMSI code, the ICCID code and the MSISDN number to OTA server 103. The OTA server 103 stores this information in its database.

Next, in step 510, the OTA server 103 is synchronized with the HLR/AUC database 104 in a manner similar to that in step 410 described hereinbefore with reference to FIG. 4. In step 512, the subscriber 111 switches on the mobile terminal with the SIM card 101 contained therein. By doing so, the subscriber 111 automatically sends a short message to the SMSC element 105 in a pre-defined format. In step 514, the SMSC element 105 forwards this short message to the OTA server 103. In step 416, the OTA server 103 extracts the MSISDN number from the short message and assigns an effective IMSI code to the subscriber 111. Furthermore, the OTA server 103 updates the record of the subscriber 111 in the HLR/AUC database 104. In step 518, the OTA server 103 sends a special short message to the SMCS element 105 in the pre-defined format. The special short message contains the effective IMSI code of the subscriber 111.

Next, in step 520, the SMSC element 105 sends the special short message with the effective IMSI code to the subscriber 111. In step 522, the subscriber 111 successfully receives the short message. The IMSI update element 224 contained in the SIM card 101 replaces the initial IMSI code by the effective IMSI code and assigns an effective key Ki to the SIM card 101 and then shuts down the mobile terminal. The system setting is completed when the mobile terminal is switched on.

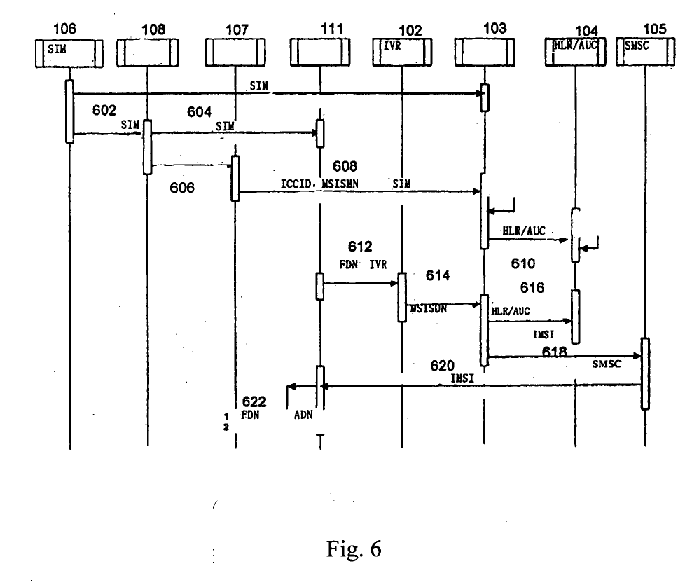

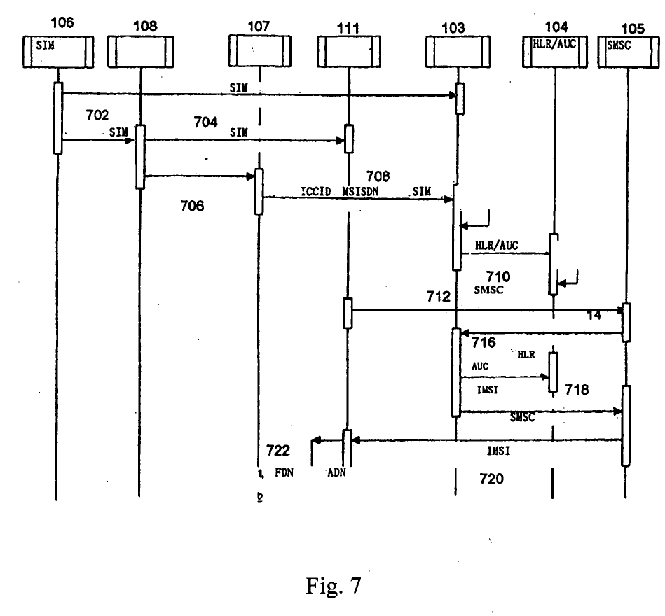

As described hereinbefore, placing a call or sending a short message can activate a new SIM card. There is no need for the reseller 108 to participate in this process. However, the invention also provides processes where the reseller 108 can participate, as described hereinafter with reference to FIG. 6 and FIG. 7.

FIG. 6 illustrates a method of over-the-air SIM card activation in which the reseller 108 participates. The method is based on placing a call. In step 602, the SIM card customization center 106 customizes the SIM card 101, allocates the customized SIM card 101 to the reseller 108, and delivers initial information of the SIM card 101 to the OTA server 103. The initial information comprises an initial IMSI code and the ICCID code temporarily assigned to the SIM card 101.

In step 604, the reseller 108 sells the SIM card 101 to the subscriber 111, and allocates an MSISDN number to the SIM card 101. In step 606, the reseller 108 transfers SIM card information to the commercial agent 107. In step 608, the commercial agent 107 delivers the SIM card information to the OTA server 103. The SIM card information comprises the initial IMSI code, the ICCID code and the MSISDN number. The OTA server 103 stores this information in its database.

Next, in step 610, the OTA server 103 is synchronized with the HLR/AUC in a manner similar to that in step 410 described hereinbefore with reference to FIG. 4. In step 612, the subscriber 111 calls the IVR sub-system 102 using the FDN. In step 614, the IVR sub-system 102 automatically responds to this call.

Furthermore, the IVR sub-system 102 extracts the MSISDN number from the call and delivers the MSISDN number to the OTA server 103. In step 616, OTA server 103 assigns the effective IMSI code to the subscriber 111. In addition, the OTA server 103 updates the record of the subscriber 111 in the HLR/AUC database 104. In step 618, the OTA server 103 sends a special short message to the SMCS element 105 in a pre-defined format. The special short message contains the effective IMSI code of the subscriber 111.

Next, in step 620, the SMSC sub-system 105 sends the special short message with the effective IMSI code to the subscriber 111. In step 622, the subscriber 111 successfully receives the short message. The IMSI update element 224 contained in the SIM card 101 replaces the initial IMSI code by the effective IMSI code and changes the FDN into an ADN. Furthermore, the IMSI update element 224 assigns an effective key Ki to the SIM card 101 and subsequently shuts down the mobile terminal. The system setting is completed when the mobile terminal is switched on again.

FIG. 7 illustrates another method of over-the-air SIM card activation in which the reseller 108 participates. The method is based on the use of short message services. In step 702, the SIM card customization center 106 customizes SIM card 101 and allocates the customized SIM card 101 to the reseller 108. The SIM card customization center 106 delivers initial information of the SIM card 101 to the OTA server 103. The initial information comprises an initial IMSI code and an ICCID code temporarily assigned to the SIM card 101. In step 704, the reseller 108 assigns an MSISDN number to the SIM card 101. In step 706, the reseller 108 delivers SIM card information to the OTA server 103. The SIM card information comprises the initial IMSI code, the ICCID code and the MSISDN number. In step 706, the OTA server 103 stores this information in its database.

Next, in step 710, the OTA server 103 is synchronized with the HLR/AUC database 104 in a manner similar to that in step 410 described hereinbefore with reference to FIG. 4. In step 712, the subscriber 111 switches on the mobile terminal with the SIM card contained therein, which automatically sends a short message to the SMSC element 105 in pre-defined format. In step 714, the SMSC element 105 forwards the short message to the OTA server 103. In step 716, the OTA server 103 extracts the MSISDN number from the short message, assigns an effective IMSI code to the subscriber 111, and updates the record of subscriber 111 in HLR/AUC database 104. In step 718, the OTA server 103 sends a special short message to the SMSC element 105 in the pre-defined format. The special short message contains the effective IMSI code of the subscriber 111.

Next, in step 720, the SMSC sub-system 105 sends the special short message with new IMSI code to subscriber 111. In step 722, the subscriber 111 successfully receives the short message. The IMSI update element 224 contained in the SIM card 101 replaces the initial IMSI code wit the effective IMSI code. Furthermore, IMSI update element 224 assigns an effective key Ki to the SIM card 101 and, subsequently, switches off the mobile terminal. The system setting is completed when mobile terminal is switched on again,

The difference between the methods illustrated in FIGS. 4 and 5, on the one hand, and the methods described with reference to FIGS. 6 and 7, on the other hand, substantially lies in the first two steps. In the methods illustrated in FIGS. 6 and 7, the SIM card customization center 106 assigns the reseller 108 to the SIM card 101 and, subsequently, the reseller 108 sells the SIM card 101 to the subscriber 111 and delivers the corresponding SIM card information to the commercial agent 107.

The description hereinbefore illustrates various over-the-air SIM card activation methods that provide many advantages. It alleviates restrictions of HLR region distribution on available SIM card IMSI codes. Consequently, it allows commercial agents or reseller to reduce their stock of SIM cards, which provides economical advantages in terms of capital velocity. It also allows subscribers to purchase SIM cards in a more convenient and easy fashion.

The description hereinbefore also illustrates the following characteristics. An identity module (SIM 101) is activated in the following manner. A customization center (106) stores an initial identity code (IMSI) in the identity module (101) and communicates the initial identity code to a network management system (103, 104). A distributor (107, 108) assigns a communication address (MSISDN) to the identity module and (101) communicates the communication address together with the initial identity code to the network management system (103, 104). The identity module (101) contacts the network management system (103, 104) via a communication device (mobile phone), whereby the network management system (103, 104) receives the initial identity code together with the communication address. The network management system (103, 104) recognizes the initial identity code together with the communication address and, in response, assigns an effective identity code to the identity module (101). Subsequently, the network management system (103, 104) sends a message to the communication device (mobile phone). This message (a special SMS) comprises the effective identity code. The identity module (101) receives the message via the communication device, extracts the effective identity code from the message and stores the effective identity code for future use.

The drawings and their description hereinbefore illustrate rather than limit the invention. It will be evident that there are numerous alternatives, which fall within the scope of the appended claims. In this respect, the following closing remarks are made.

The invention has been described in detail by way of example with reference to a mobile communication network. However, the characteristics summarized hereinbefore can equally be implemented in numerous other types of networks, such as, for example, a local area network (LAN).

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

Any reference sign in a claim should not be construed as limiting the claim. The word “comprising” does not exclude the presence of other elements or steps

1. An identity module for a communication device, the identity module comprising:
a storage medium wherein an initial identity code is stored; and
a processor arranged to receive a communication address, to deliver the initial identity code together with the communication address to a network management system via the communication device, to receive a message from the network management system via the communication device, which message comprises an effective identity code that the network management system has assigned to the identity module, to extract the effective identity code from that message, and to store the effective identity code for future use.

2. An identity module as claimed in claim 1, wherein the processor is further arranged to reboot the communication device after the effective identity code is stored for future use.

3. An identity module as claimed in claim 1, wherein the identity module further comprises a fixed director number for effecting a call to an interactive voice responder via the communication device, the interactive voice responder being part of the network management system and being arranged to extract the initial identity code and the communication address from the call.

4. An identity module as claimed in claim 1, wherein the processor is further arranged to send a message to a message service center via the mobile terminal, the message service center being part of the network management system, the message comprising the initial identity code and the communication address.

5. An identity module as claimed in claim 1, wherein the identity module comprises a module-identifier code and the processor is further arranged to deliver the module-identifier code to the network management system in addition to the identity code and the communication address.

6-11. (canceled)

12. A method of activating an identity module comprising an initial identity code and a communication address, the method comprising:
a first activation step in which the identity module contacts a network management system via a communication device, whereby the network management system receives the initial identity code together with the communication address;
a second activation in which the network management system recognizes the initial identity code together with the communication address and, in response, assigns an effective identity code to the identity module and, subsequently, sends a message to the communication device, the message comprising the effective identity code; and
a third activation step in which the identity module receives the message via the communication device, extracts the effective identity code from the message and stores the effective identity code for future use.

13. A method of activating an identity module, the method comprising:
an initial activation step in which a customization center stores an initial identity code in the identity module and communicates the initial identity code to a network management system;
a distribution step in which a distributor assigns a communication address to the identity module and communicates the communication address together with the initial identity code to the network management system;
a first activation step in which the identity module contacts the network management system via a communication device, whereby the network management system receives the initial identity code together with the communication address;
a second activation in which the network management system recognizes the initial identity code together with the communication address and, in response, assigns an effective identity code to the identity module and, subsequently, sends a message to the communication device, the message comprising the effective identity code; and
a third activation step in which the identity module receives the message via the communication device, extracts the effective identity code from the message and stores the effective identity code for future use.

14. A method of activating an identity module as claimed in claim 11, wherein the second activation step, the network management system further assigns an effective key to the identity module and includes the effective key in the message, and wherein in the third activation step the identity module extracts the effective key from the message and stores the effective key for future use.

15. A method of activating an identity module as claimed in claim 12, wherein the second activation step, the network management system further assigns an effective key to the identity module and includes the effective key in the message, and wherein in the third activation step the identity module extracts the effective key from the message and stores the effective key for future use.

16. A network management system for activating an identity module comprising an initial identity code and a communication address associated therewith, the network management system being arranged to receive the initial identity code and the communication address comprised in the identity module, to recognize the initial identity code and the communication address and, in response, to assign an effective identity code to the identity module and, subsequently, to send a message to the identity module, the message comprising the effective identity code, so that the identity module can extract the effective identity code from the message and store the effective identity code for future use.

17. A computer program product for an identity module, the computer program product comprising a set of instructions that, when the set of instructions is loaded into the identity module, allows the identity module to:
receive a communication address;
deliver the communication address together with an initial identity code comprised in the identity module, to a network management system via a communication device,
receive a message from the network management system via the communication device,
which message comprises an effective identity code that the network management system has assigned to the identity module,
extract the effective identity code from that message, and to store the effective identity for future use.

18. A computer program product for a network management system, the computer program product comprising a set of instructions that, when the set of instructions is loaded into the network management system, allows the network management system to:
receive an initial identity code and a communication address comprised in the identity module;
recognize the initial identity code and the communication address and, in response,
assign an effective identity code to the identity module and, subsequently,
send a message to the identity module, the message comprising the effective identity so that the identity module can extract the effective identity code from the message and the effective identity code for future use.
